(19) United States
(12) Patent Application Publication
(10) Pub. No.: US 2014/0130304 A1
(43) Pub. Date: May 15, 2014

(54) LAPTOP KEYBOARD TILTING ASSEMBLY

(71) Applicant: KING FAHD UNIVERSITY OF PETROLEUM AND MINERALS, DHAHRAN (SA)

(72) Inventors: MEHMET DONDURUR, CROFTON, MD (US); AHMET Z. SAHIN, DHAHRAN (SA)

(73) Assignee: KING FAHD UNIVERSITY OF PETROLEUM AND MINERALS, DHAHRAN (SA)

(21) Appl. No.: 14/162,574

(22) Filed: Jan. 23, 2014

Related U.S. Application Data
(62) Division of application No. 13/472,253, filed on May 15, 2012.

(51) Int. Cl. G06F 1/16

(52) U.S. Cl. CPC G06F 1/1667
USPC 16/337

(57) ABSTRACT

The laptop keyboard tilting assembly includes at least one friction articulating hinge assembly pivotally attached to a monitor and keyboard base or section of a laptop computer. The articulating-hinge assembly includes at least two pivots, one pivot being connected to the monitor and the other pivot being connected to the keyboard base. Rotation of the monitor in one direction unfolds the laptop computer, and rotation of the keyboard base in the opposite direction tilts the keyboard base into a more comfortable angle for typing, which reduces user strain and prevents potential injuries, especially for extended sessions.

### BACKGROUND OF THE INVENTION

1. Field of the Invention

The present invention relates to laptop computers, and particularly to a laptop keyboard tilting assembly that selectively slants the keyboard into a more comfortable position, thereby reducing potential fatigue and injuries.

2. Description of the Related Art

Laptop computers and other similar portable computing devices have become prevalent in many facets of life. These devices allow a person to be productive anywhere. While being very convenient and utilitarian, the ergonomics of the typical laptop computer has not changed much since its inception. The typical laptop computer consists of a base keyboard housing, which houses the majority of the internal electronics, inputs, ports, etc. and a foldable monitor. The keyboard is typically substantially flat or slightly angled, but this orientation is static or fixed. Over time, this orientation of the keyboard can stress and fatigue the user's arms, wrist, hands and fingers. Due to the amount of time one may spend using laptop computers, whether for work or personal enjoyment, there exists a real concern for potential harm from such maladies as carpal tunnel syndrome.

When typing on a keyboard for any extended length of time, it is generally more comfortable to have the keyboard angled more than a few degrees so that the hands can be placed in a more relaxed position. For example, many keyboards for desktop computers include foldable legs at the back of the keyboard that will elevate the rear of the keyboard when placed atop a desk and place the keyboard at a more comfortable position for most users.

Similar solutions have been proposed with respect to laptop computers. One solution involves a sub-base housing underlying the keyboard base. The sub-base housing includes an integrated levering mechanism that elevates and supports the rear portion of the keyboard base as the monitor unfolds. While functional, this adds bulk and additional hardware, which detracts from the portable aspects of laptop computers. Another solution involves the use of extensions or legs on the monitor that cause the keyboard base to assume an angled position as the monitor unfolds. These legs provide adequate support and facilitate the desired elevation, but any structural extension of this nature can be prone to accidental damage or breaks from normal wear.

Thus, a laptop keyboard tilting assembly solving the aforementioned problems is desired.

### SUMMARY OF THE INVENTION

The laptop keyboard tilting assembly includes at least one friction articulating-hinge assembly pivotally attached to a monitor and keyboard base or section of a laptop computer. The articulating-hinge assembly includes at least two pivots, one pivot being connected to the monitor, and the other pivot being connected to the keyboard base. Rotation of the monitor in one direction unfolds the laptop computer, and rotation of the keyboard base in the opposite direction tilts the keyboard base into a more comfortable angle for typing, which reduces user strain and prevents potential injuries, especially for extended sessions.

These and other features of the present invention will become readily apparent upon further review of the following specification and drawings.

### BRIEF DESCRIPTION OF THE DRAWINGS

FIG. 1 is a perspective view of a laptop computer having a laptop keyboard tilting assembly according to the present invention.

FIG. 2 is a side view of the laptop computer of FIG. 1, diagrammatically showing the tilting assembly.

FIG. 3 is a partial environmental perspective view of an alternative embodiment of a laptop keyboard tilting assembly according to the present invention.

FIG. 4 is a side view of a laptop computer having the laptop keyboard tilting assembly of FIG. 3.

FIG. 5 is an enlarged partial perspective view of another alternative embodiment of a laptop keyboard tilting assembly according to the present invention.

FIG. 6 is an enlarged partial perspective view of a further alternative embodiment of a laptop keyboard tilting assembly according to the present invention.

FIG. 7 is a diagrammatic side view of a laptop computer having the laptop keyboard tilting assembly of FIG. 6.

FIGS. 8A, 8B, and 8C are diagrammatic side views of a still further alternative embodiment of a laptop keyboard tilting assembly according to the present invention, showing different stages in the process of unfolding the laptop computer.

FIG. 9 is a perspective view of another alternative embodiment of a laptop keyboard tilting assembly according to the present invention.

Similar reference characters denote corresponding features consistently throughout the attached drawings.

### DETAILED DESCRIPTION OF THE PREFERRED EMBODIMENTS

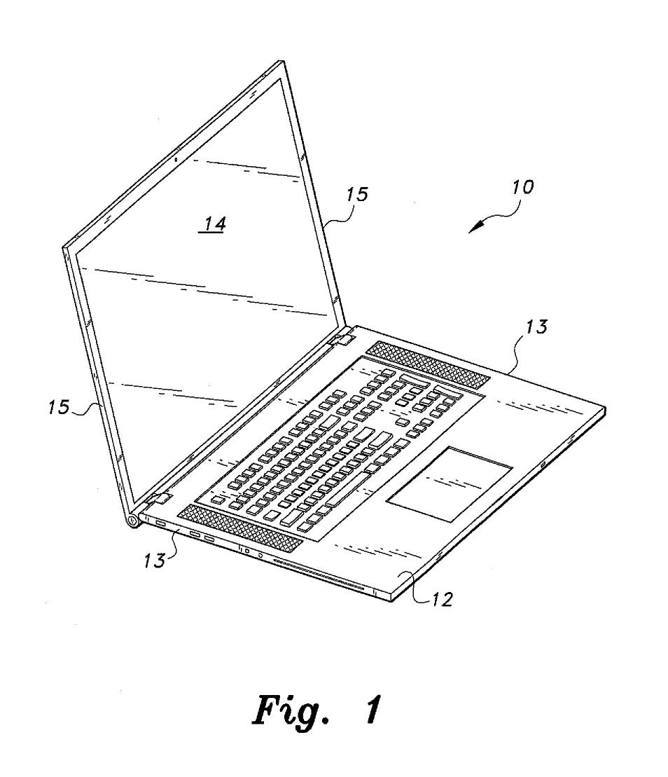

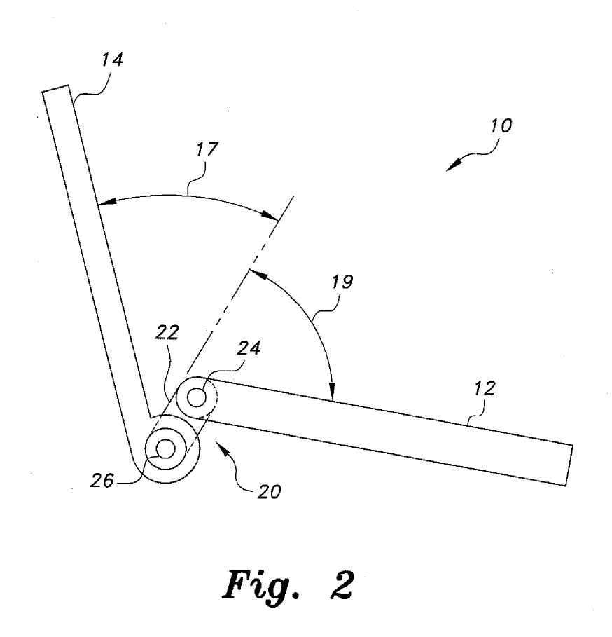

The laptop keyboard tilting assembly, a first embodiment of which is generally referred to in FIGS. 1 and 2 by the reference number 10, provides a user-defined adjustable tilting of the keyboard base or section for extended comfortable typing. As shown in FIGS. 1 and 2, the keyboard tilting assembly 10 includes an articulating hinge mechanism 20 pivotally connected to both a keyboard base or section 12 and a monitor 14 of a laptop computer. In this embodiment, the articulating hinge mechanism 20 is preferably disposed inward a short distance from the sides 13 of the keyboard base 12 and the sides 15 of the monitor 14, e.g., about one inch. It is to be understood that any number of articulating hinge mechanisms can be used to facilitate selective unfolding and tilting of the keyboard base for any of the embodiments described herein.

Each articulating hinge mechanism 20 is a friction hinge that includes an elongate leaf, beam or connector arm 22 having a relatively short cylindrical first pivot 24 at one end and a relatively short cylindrical second pivot 26 at the opposite end, each pivot defining respective first and second axes of rotation. The length of the connector arm 22 is preferably about the same as the thickness of the overall laptop computer in order to avoid protrusions that can potentially snag on objects, as well as for aesthetics. The first pivot 24 pivotally connects the connector arm 22 to the keyboard base 12, and the second pivot 26 pivotally connects the connector arm 22 to the monitor 14. The pivotal connections are preferably friction enhanced so that the relative positions of the keyboard base 12 and the monitor 14 can be maintained when folded and unfolded in the position desired by the user. The friction hinges are known in the art. The connector arm 22 can be a housing for the first and second pivots 24, 26 that has space therein permitting wires to be threaded between the keyboard base 12 and the monitor 14 in order to transmit power and data therebetween.

In use, the user unfolds the monitor 14 in one direction from the keyboard base 12 to or past perpendicular with respect to the keyboard base 12, as indicated by the arrow 17. While holding the monitor steady 14, the keyboard base 12 is pushed towards the monitor 14 to thereby cause the connector arm 22 to rotate about the second pivot 26 and simultaneously cause the keyboard base 12 to rotate about the first pivot 24 in the opposite direction from the unfolding monitor 14, as indicated by the arrow 19, until the desired inclination or tilt of the keyboard base 12 has been established by the user. Now the user is free to type more comfortably without undue strain. It has been found that a tilt angle of about 20°-30° degrees with respect to the support surface of the laptop computer is comfortable for most users. The above is a preferred manner of tilting the keyboard base 12, but it should be understood that other methods can be used to obtain similar results, such as resting the spine of the laptop computer on the support surface and simultaneously unfolding both sections of the laptop computer.

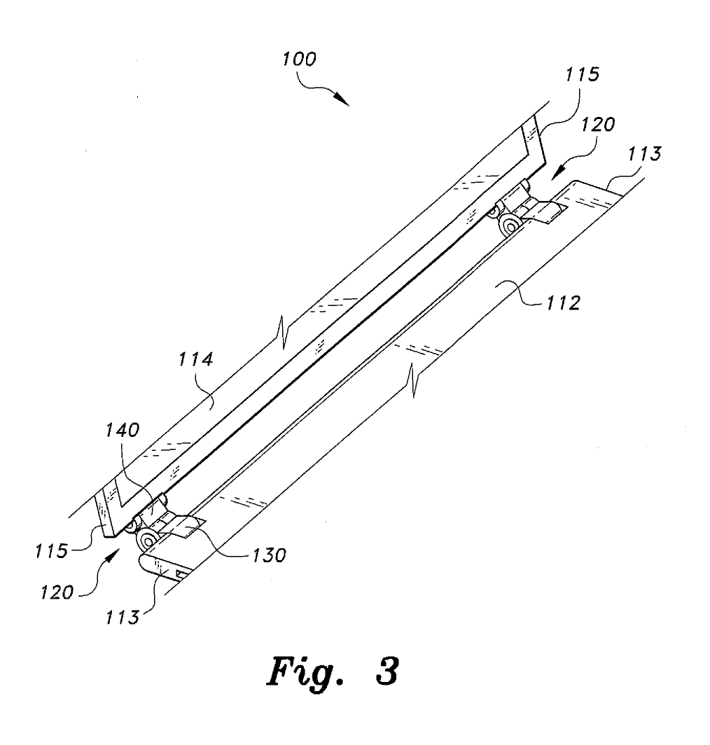

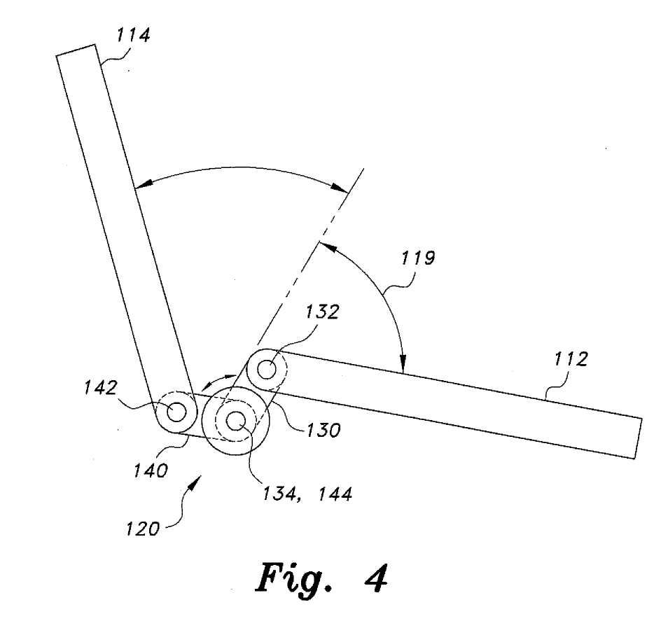

An alternative embodiment of a laptop keyboard tilting assembly 100 is shown in FIGS. 3 and 4. In this embodiment, the laptop keyboard tilting assembly 100 includes three axes of rotation. As shown, the keyboard tilting assembly 100 includes a articulating hinge mechanism 120 pivotally connected to both the keyboard base 112 and the monitor 114 of a laptop computer. Similar to the above articulating hinge mechanism 20, the articulating hinge mechanism 120 is preferably disposed a short distance from the sides 113 of the keyboard base 112 and the sides 115 of the monitor 114, e.g., about one inch.

Each articulating hinge mechanism 120 is a friction hinge that includes an elongate first connector arm 130 and an elongate second connector arm 140 pivotally connected to each other about a common pivot. The first connector arm 130 includes a cylindrical first pivot 132 at one end and a cylindrical second pivot 134 at the opposite end. Similarly, the second connector arm 140 includes a cylindrical first pivot 142 at one end and a cylindrical second pivot 144 at the opposite end. The first pivot 132 of the first connector arm 130 is pivotally attached to the keyboard base 112 and defines a first axis of rotation. The first pivot 142 of the second connector arm 140 is pivotally attached to the monitor 114 and defines a second axis of rotation. The first connector arm 130 and the second connector arm 140 are pivotally connected to each other at the second pivots 134, 144, which together define a third axis of rotation. All of the pivot connections are preferably friction enhanced, and both the first and second connector arms 130, 140 can include space for threading necessary wires.

In use, the laptop computer can be unfolded in a similar manner as that described above to set the desired tilt for the keyboard base 112, as indicated by the arrows 117, 119. However, the three different axes of rotation provide the user with finer adjustments of the tilt and of the relative positions of the keyboard base 112 and the monitor 114, e.g., in addition to the tilt, the relative distance between the keyboard 112 and the monitor 114 can be adjusted and set.

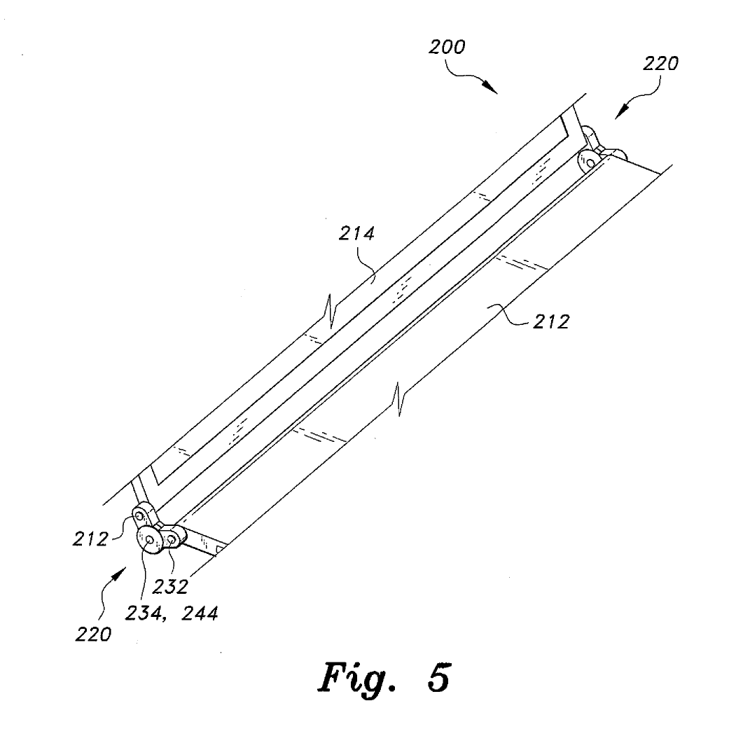

A further alternative embodiment of a laptop keyboard tilting assembly is shown in FIG. 5. In this embodiment, the laptop keyboard tilting assembly 200 includes a friction articulating hinge mechanism 220 similar in construction to the articulating hinge mechanism 120, having three axes of rotation at the first pivot 232, the second pivot 242 and the common third pivot 234, 244. In contrast to the articulating hinge mechanism 120, the articulating hinge mechanism 220 is disposed on the sides of the keyboard base 212 and the monitor 214. The articulating hinge mechanism 220 can also be disposed flush with the sides instead of extending outwardly therefrom. This embodiment is an example showing that the hinge mechanisms described herein can be placed anywhere to facilitate selective folding, unfolding and tilting of the keyboard for laptop computers.

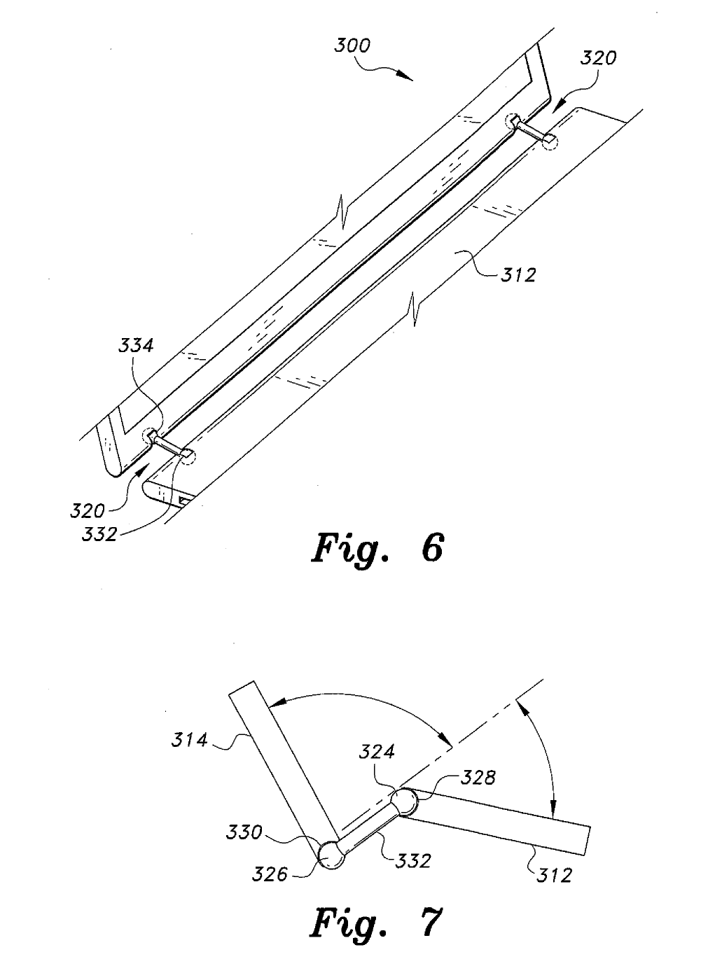

A still further alternative embodiment of a laptop keyboard tilting assembly 300 is shown in FIGS. 6 and 7. This embodiment is similar to the laptop keyboard tilting assembly 10, except that the pivot ends are replaced with ball and socket joints. As shown, the laptop keyboard tilting assembly 300 includes a friction articulating hinge mechanism 320 pivotally connecting a keyboard base 312 and a monitor 314 to each other. The articulating hinge mechanism 320 includes a connector arm 322 having a ball first pivot 324 at one end and a ball second pivot 326 at the opposite end, each pivot 324, 326 defining respective first and second axes of rotation. The first pivot 324 pivotally connects the connector arm 322 to the keyboard base 312 via friction engagement with a corresponding first socket 328 in the keyboard base 312. Similarly, the second pivot 324 pivotally connects the connector arm 322 to the monitor 314 via friction engagement with a corresponding second socket 330 in the monitor 314. Arcuate grooves or slots 332 on the keyboard base 312 and arcuate grooves or slots 334 on the monitor 314, through which the articulating hinge mechanism 320 is joined, prevent wayward skewing of the monitor 314 or the keyboard base 312 during the unfolding and tilting operation. In all other respects, the laptop keyboard tilting mechanism 300 functions similarly to the laptop keyboard tilting mechanism 10.

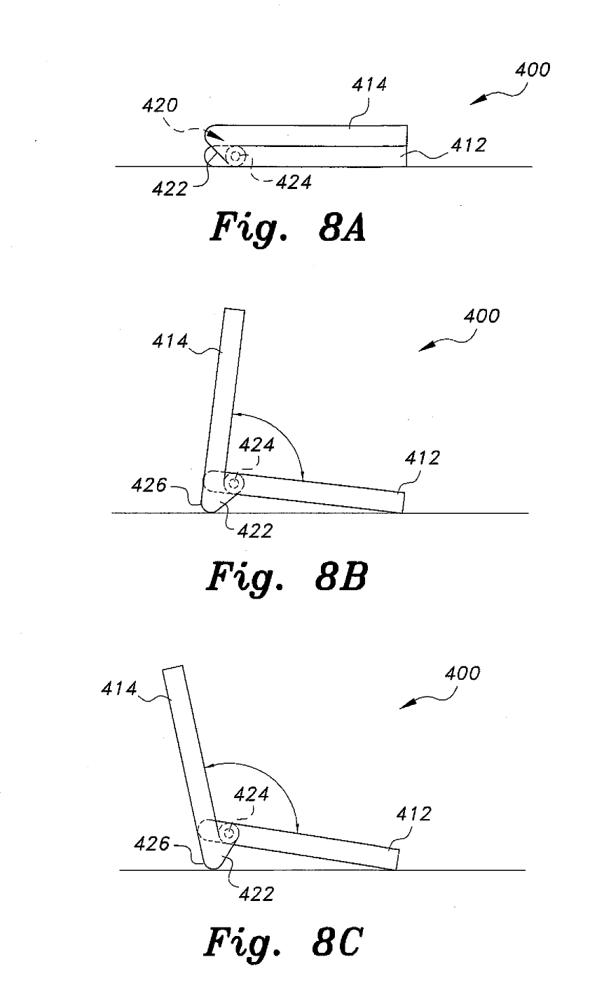

A still further alternative embodiment of a laptop keyboard tilting assembly 400 is shown in FIGS. 8A-8C. In this embodiment, the friction hinge mechanism 420 is a single pivot hinge connected to one of the two halves of a laptop computer. As shown, the laptop keyboard tilting assembly 400 includes the hinge mechanism 420 having at least one angled connector arm 422 integral or unitary with the monitor 414. The distal end of the connector arm 422 from the monitor 414 is frictionally and pivotally attached to the keyboard base 412 at the pivot 424. The integral and angular connection between the connector arm 422 and the monitor 414 forms an extension or hump 426 at the bottom of the monitor 414.

The schematic diagrams of FIGS. 8A-8C show the laptop computer in folded, intermediate unfolded, and fully unfolded positions, respectively. During the unfolding process, the connector arm 422 leverages the keyboard base 412, causing the base 412 to rotate about the pivot 424. The fulcrum for the leveraging action is provided by the extension 426 when the extension rests on the support surface during the unfolding process, as shown in FIG. 8B. Once fully unfolded, the keyboard base 412 is tilted to a predetermined comfortable angle.

The above embodiment is exemplary of a hinge mechanism where one end is fixed to the monitor or to the keyboard base of a laptop computer. As such, any of the previous embodiments can be similarly constructed so that one of the pivots is not a pivot, but rather a permanent, fixed connection to either the monitor or the keyboard.

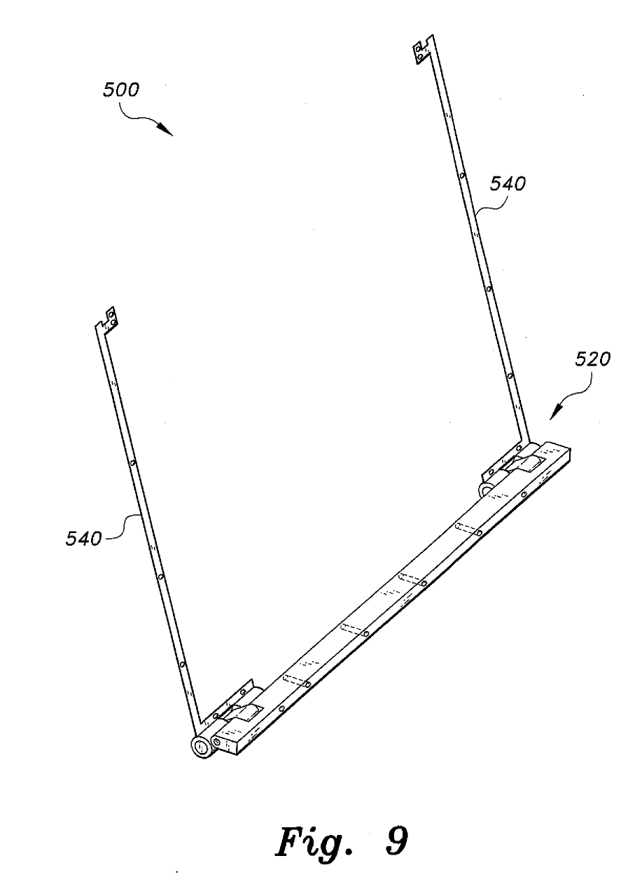

A still further alternative embodiment of a laptop keyboard tilting assembly 500 is shown in FIG. 9. In this embodiment, the laptop keyboard tilting assembly 500 permits mounting of the interior screen of a monitor. As shown, the laptop keyboard tilting assembly 500 includes a friction articulating hinge mechanism 520 similar in function to the articulating hinge mechanism 20. Additionally, the articulating hinge mechanism 520 includes a pair of upright screen mounting brackets 540 integrally attached thereon. These mounting brackets 540 facilitate support and mounting of the screen in typical laptop computer monitors. This permits servicing and replacement of failed or damaged screens. It is to be understood that similar screen mounting brackets can be applied to the previous embodiments.

It is to be understood that the present invention is not limited to the embodiments described above, but encompasses any and all embodiments within the scope of the following claims.

1. A laptop keyboard tilting assembly for a laptop computer having a monitor and a keyboard base, the tilting assembly comprising at least one friction articulating hinge mechanism adapted for being connected to the monitor and to the keyboard base to facilitate selective folding and unfolding therebetween, the at least one articulating hinge mechanism having:
at least one elongate connector arm having a first end and a second end;
a first pivot at the first end of the at least one connector arm, the first pivot being adapted for frictional, pivotal connection to the keyboard base, the first pivot defining a first axis of rotation; and
a second pivot at the second end of the at least one connector arm, the second pivot being adapted for frictional, pivotal connection to the monitor, the second pivot defining a second axis of rotation;
wherein selective rotation of the monitor about the second end of the at least one connector arm in one direction unfolds the monitor, and selective rotation of the keyboard base about the first end of the at least one connector arm in the opposite direction tilts the keyboard base to an angle comfortable for typing.

2-3. (canceled)

4. The laptop keyboard tilting assembly according to claim 1, wherein said pivots comprises frictional ball and socket joints.

5-8. (canceled)
